(19) United States
(12) Patent Application Publication
(10) Pub. No.: US 2025/0304200 A1
(43) Pub. Date: Oct. 2, 2025

(54) TELESCOPIC ASSEMBLY WITH A NON-UNIFORM BUSHING

(71) Applicant: Fox Factory, Inc., Duluth, GA (US)

(72) Inventors: Thomas Pollock, Mills River, NC (US); Mark Smith, Fletcher, NC (US); Christopher Otterness, Asheville, NC (US); John Kiffmeyer, Asheville, NC (US); Joshua Coaplen, Asheville, NC (US); Ian Baldwin, Alexander, NC (US)

(21) Appl. No.: 18/624,333

(22) Filed: Apr. 2, 2024

(51) Int. Cl. B62J 1/06; B62J 1/08

(52) U.S. Cl. CPC B62J 1/06; B62J 1/08; B62J 2001/085

(57) ABSTRACT

A telescopic assembly with a non-uniform thickness bushing is provided. The telescopic assembly includes a second telescopic member slidably coupled within a first telescopic member. The non-uniform thickness bushing is coupled to an end of the second telescopic member and located between the second telescopic member and the first telescopic member. The non-uniform thickness bushing includes a bushing body forming a ring with an aperture extending therethrough; a first portion extending from the bushing body on one side of the ring, the first portion having a first thickness; and a second portion extending from the bushing body on a side of the ring opposite the side of the first portion, the second portion having a second thickness. The first thickness is greater than the second thickness placing an axis of the second telescopic member in a position out of coaxial alignment with an axis of the first telescopic.

### BACKGROUND OF THE INVENTION

### Technical Field

This invention relates generally to a telescopic assembly for use in a vehicle and more particularly to telescopic assembly with a non-uniform thickness bushing for use in a vehicle.

### State of the Art

Telescopic assemblies are utilized in vehicles for various reasons. Often the telescopic assemblies include an inner post and an outer post that are slidable with respect to each other. These telescopic assemblies often require a force to move the slidable member. In some instances, the applied load is not directed to the telescopic assembly in an axial direction, but at an angle that results in a force that is axial and a force that is a sideload force in at least one other direction. If the fitting between the inner post and the outer post is loose, then the sideload force can result in the inner post binding with the outer post and inhibiting the proper function of the telescopic assembly.

An example of this type of telescopic assembly is a dropper seat post. When riding a dropper seat post, the bushings ensure the post can slide freely during extension and compression. With a loose fit, the seat post can rattle or make noise. Additionally, if the fit is too loose the upper post (inner post) can shift in the lower post (outer post) and contact components that are not supposed to be in the load path during extension or compression of the dropper seat post. This can result in a high friction ride feel, cause the seat post to bind and not freely extend or compress, or damage internal components. This experience is worsened when a rider sits on the seat post and tries to actuate the dropper seat post. The rider's body weight is never purely applied axially to the seat or the seat post and imparts a sideload to the system. In cases with a significant sideload the binding from a loose fit can become more extreme causing the seat post to not compress completely. This can be perceived negatively by the rider making the seat post feel “cheap” or feel excessive/distracting movement during variable pedaling forces. This is an inherent problem amongst all dropper seat posts and is something usually designed around. One way to combat this is with bushings fitting tightly, resulting in other problems. If the bushing fit is too tight, the seat post will also have high running friction. This can create a post that will not freely extend or compress.

Accordingly, there is a need for an improved telescopic assembly, such as a dropper seat post, with a non-uniform thickness bushing.

### SUMMARY OF THE INVENTION

An embodiment includes a non-uniform thickness bushing for a telescopic assembly used in a vehicle, the non-uniform thickness bushing comprising: a bushing body forming a ring with an aperture extending therethrough; a first portion extending from the bushing body on one side of the ring, the first portion having a first thickness; and a second portion extending from the bushing body on a side of the ring opposite the side of the first portion, the second portion having a second thickness, wherein the first thickness is greater than the second thickness.

Another embodiment includes a telescopic suspension comprising: a telescopic assembly comprising a first telescopic member having an axis and a second telescopic member having an axis, the second telescopic member slidably coupled within the first telescopic member; a non-uniform thickness bushing coupled to an end of the second telescopic member and located between an outer surface of the second telescopic member and an inner surface of the first telescopic member, wherein the non-uniform thickness bushing comprises: a bushing body forming a ring with an aperture extending therethrough; a first portion extending from the bushing body on one side of the ring, the first portion having a first thickness; and a second portion extending from the bushing body on a side of the ring opposite the side of the first portion, the second portion having a second thickness, wherein the first thickness is greater than the second thickness; and wherein the non-uniform thickness bushing places the axis of the second telescopic member in a position out of coaxial alignment with the axis of the first telescopic member when there is no load on the second telescopic member.

Another embodiment may include a dropper seat post comprising: a first post having an axis; a second post having an axis, the second post slidably coupled within the first post; a non-uniform thickness bushing coupled to an end of the second post and located between an outer surface of the second post and an inner surface of the first post, wherein the non-uniform thickness bushing comprises: a bushing body forming a ring with an aperture extending therethrough; a first portion extending from the bushing body on one side of the ring, the first portion having a first thickness that when coupled to the second post faces a front of a bicycle to which the dropper seat post is coupled; and a second portion extending from the bushing body on a side of the ring opposite the side of the first portion, the second portion having a second thickness, wherein the first thickness is greater than the second thickness; and wherein the non-uniform thickness bushing places the axis of the second post in a position out of coaxial alignment with the axis of the first post when there is no load on the second post.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a side view of a bicycle with a dropper seat post according to an embodiment;

FIG. 2 is a perspective view of a non-uniform thickness bushing for use with a dropper seat post according to an embodiment;

FIG. 3A is a section view of a dropper seat post with a non-uniform thickness bushing according to an embodiment;

FIG. 3B is a zoomed in section view of a dropper seat post with a non-uniform thickness bushing according to an embodiment;

FIG. 3C is a zoomed in section view of a dropper seat post with a non-uniform thickness bushing without a load on the dropper seat post according to an embodiment;

FIG. 3D is a zoomed in section view of a dropper seat post with a non-uniform thickness bushing with a load on the dropper seat post according to an embodiment;

FIG. 4A is a side view of an inner post of a dropper seat post with a non-uniform thickness bushing according to an embodiment;

FIG. 4B is an end view of a dropper seat post with a non-uniform thickness bushing according to an embodiment;

FIG. 5A is a top view of a non-uniform thickness bushing for use with a dropper seat post according to an embodiment;

FIG. 5B is a perspective view of a non-uniform thickness bushing for use with a dropper seat post according to an embodiment;

FIG. 6A is a top view of another embodiment of a non-uniform thickness bushing for use with a dropper seat post according to an embodiment;

FIG. 6B is a perspective view of the non-uniform thickness bushing of FIG. 6A for use with a dropper seat post according to an embodiment;

FIG. 7A is a top view of another embodiment of a non-uniform thickness bushing for use with a dropper seat post according to an embodiment;

FIG. 7B is a perspective view of the non-uniform thickness bushing of FIG. 7A for use with a dropper seat post according to an embodiment;

FIG. 8A is a top view of another embodiment of a non-uniform thickness bushing for use with a dropper seat post according to an embodiment;

FIG. 8B is a perspective view of the non-uniform thickness bushing of FIG. 8A for use with a dropper seat post according to an embodiment;

FIG. 9A is a top view of another embodiment of a non-uniform thickness bushing for use with a dropper seat post according to an embodiment;

FIG. 9B is a perspective view of the non-uniform thickness bushing of FIG. 9A for use with a dropper seat post according to an embodiment;

FIG. 10A is a top view of another embodiment of a non-uniform thickness bushing for use with a dropper seat post according to an embodiment;

FIG. 10B is a perspective view of the non-uniform thickness bushing of FIG. 10A for use with a dropper seat post according to an embodiment;

FIG. 11A is a top view of another embodiment of a non-uniform thickness bushing for use with a dropper seat post according to an embodiment;

FIG. 11B is a perspective view of the non-uniform thickness bushing of FIG. 11A for use with a dropper seat post according to an embodiment;

FIG. 12A is a top view of an embodiment of a uniform bushing according to another embodiment; and

FIG. 12 B is a perspective view of the uniform bushing of FIG. 112A according to an embodiment.

### DETAILED DESCRIPTION OF EMBODIMENTS OF THE INVENTION

As discussed above, embodiments of the present invention relate to a telescopic assembly, such as a dropper seat post, with a non-uniform thickness bushing.

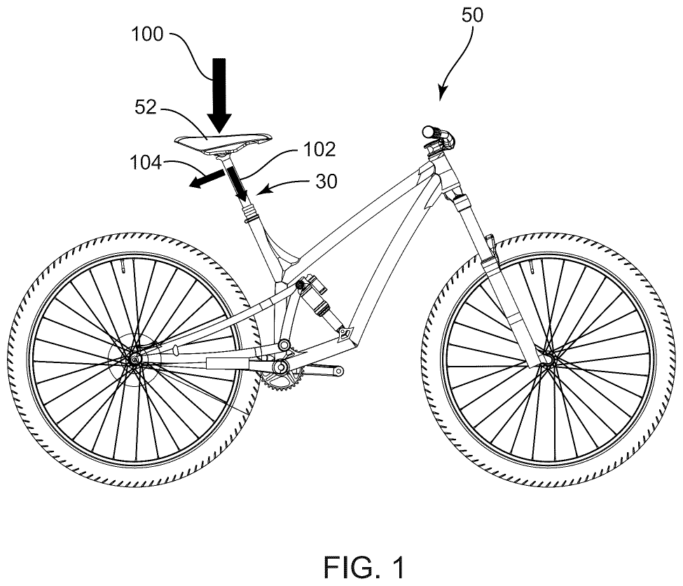

Referring to the drawings, FIG. 1 depicts an example, without limitation, of a dropper seat post 30 coupled to a bicycle 50. As depicted, when a rider sits on a seat 52 coupled to the dropper seat post 30 he or she imparts a load force 100 applied to the seat 52. This load 100 is not applied fully axially down the axis of the dropper seat post 30 and therefore results in an axial force 102 down the seat post 30 and a sideload force 104 toward a rear of the bicycle 50. This results in a sideload on the bushings. This loads both the upper and lower bushings in the dropper seat post 30. The direction that the sideload is applied is predictable as in the most common loading scenario the rider usually sits off a rear side of the seat, which can result in the dropper seat post 30 binding under load. This applies a load to the rear side of the upper bushing and the front side of the lower bushing, where in the rear side is the side located towards the rear of the bicycle and the front side is the side located towards the front of the bicycle.

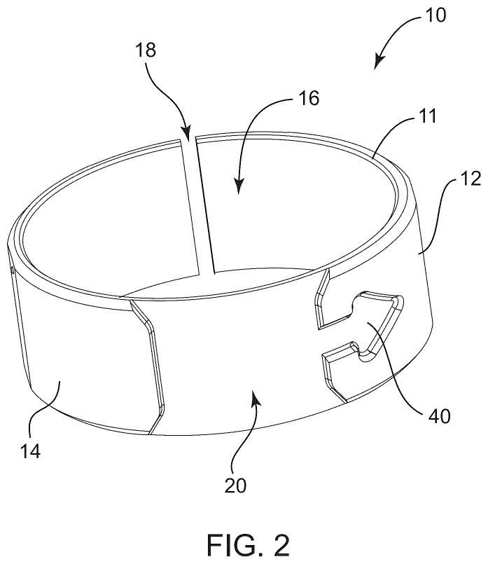

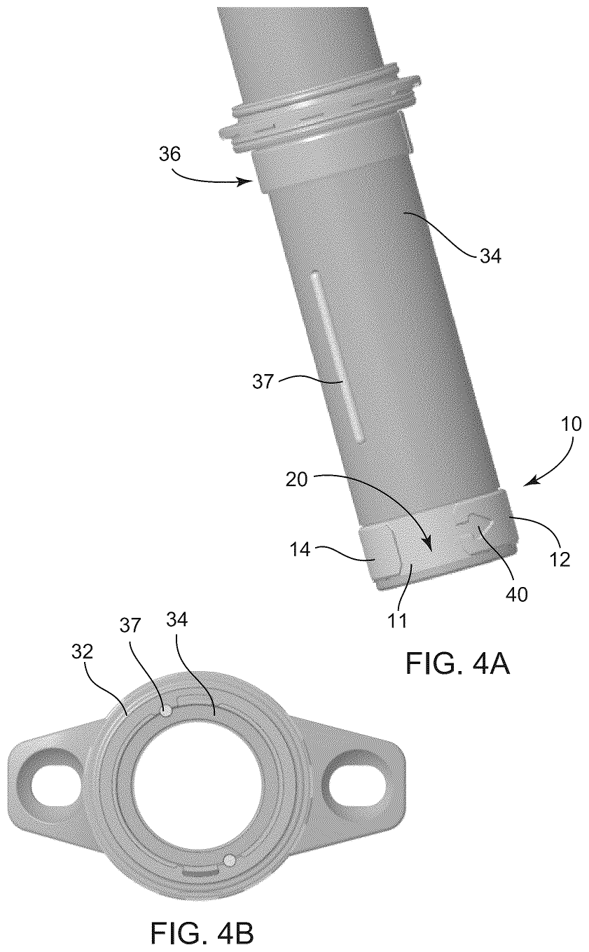

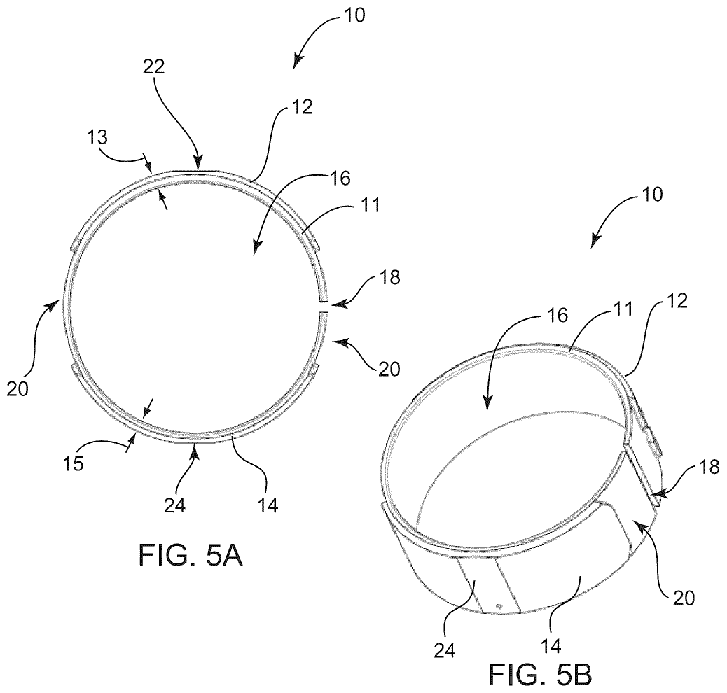

Referring to FIGS. 2-5B, an embodiment of a telescopic assembly 30 is depicted. In this embodiment, the telescopic assembly 30 depicted is a dropper seat post 30. While this disclosure discusses the dropper seat post 30, the elements and components of the dropper seat post 30 are applicable to other telescopic assemblies utilized in a vehicle, such as, but not limited to, a bicycle. The dropper seat post 30 may include a first post 32 (lower post), a second post 34 (upper post), a bushing 36 and a non-uniform thickness bushing 10. The second post 34 is slidable within the first post 32 and the first post 32 is removably coupled to the bicycle 50 (or other vehicle) and held in a fixed position, wherein the second post 34 slides with respect to the first post 32. The non-uniform thickness bushing 10 includes a first portion 12 having a first thickness 13 and a second portion 14 having a second thickness 15, wherein the first thickness 13 is greater than the second thickness 15. The first thickness 13 of the first portion 12 may be a continuously variable thickness when taken on a cross section of various locations along the first portion 12. The second thickness 15 of the second portion 14 may be a continuously variable thickness when taken on a cross section of various locations along the second portion 14. Even with variable thicknesses of the first thickness 13 and the second thickness 15, the first thickness 13 is generally greater than the second thickness 15.

The non-uniform thickness bushing 10 may also include a gap 20 located between the first portion 12 and the second portion 14. The gap 20 is provided so as to not interfere with internal features on the first post 32. The non-uniform thickness bushing 10 may include an aperture 16 extending therethrough and an opening 18 that allows for greater ease of installing the non-uniform thickness bushing 10 onto a bottom portion of the second post 34. An additional aid for ease of installing includes a direction indicator 40 that points to the first portion 12 of the bushing in order to assist in orienting the first portion 12 in the proper direction.

In embodiments, the first portion 12 may include a first flat surface 22 and the second portion 14 may include a second flat surface 24, wherein the first flat surface 22 is located on an opposite side of the bushing 10 from the second flat surface 24. The first and second flat surfaces 22 and 24 may be used to make molding of the bushing 10 easier, but also provide an additional benefit. The first and second flat surfaces 22 and 24 are located at the front and back respectively to help prevent binding as the bushing 10 passes through the seat post clamp on the frame.

The dropper seat post 30 includes a space 38 located between an outer surface of a bottom portion of the second post 34 and an inner surface of the first post 32. Once installed on the bottom portion of the second post 34, the first portion 12 of the non-uniform thickness bushing 10 is of a thickness (first thickness 13) to contact the inner surface of the first post 32 and biases it away from front of the bicycle 50. The second portion 14 is of a thickness (second thickness 15) that is less than the size of the space 38.

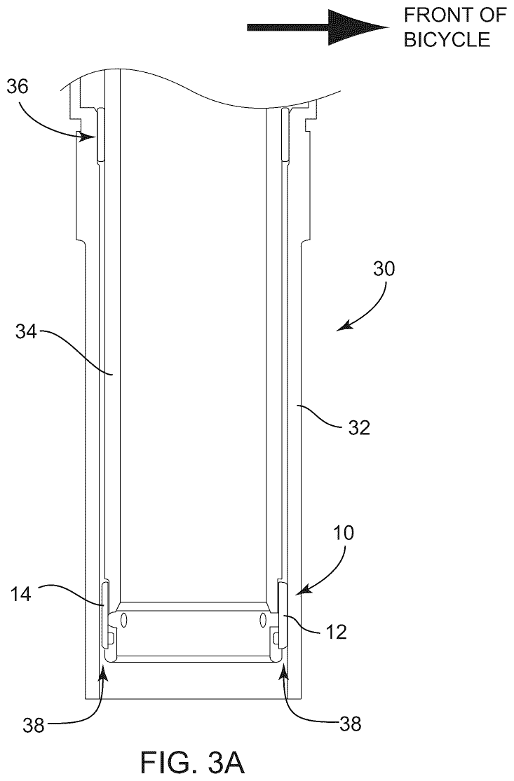

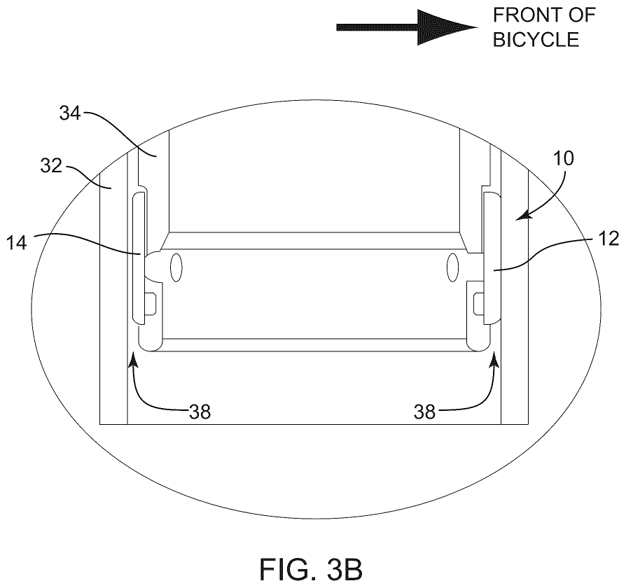

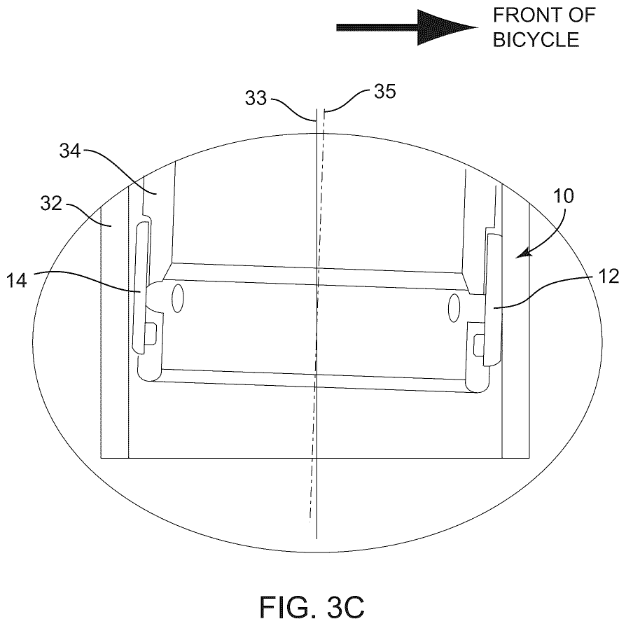

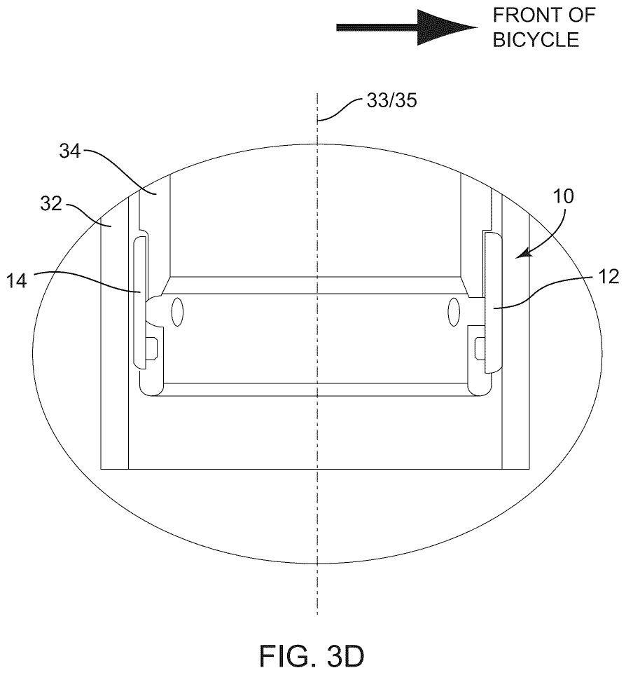

Referring additionally to FIGS. 3C and 3D, an embodiment of the dropper seat post 30 is depicted with the second post 34 at an exaggerated angle to the first post 32 in order to better depict and describe the operation of the dropper seat post 30 with a non-uniform thickness bushing 10. The first thickness 13 of the first portion 12 and the second thickness 15 of the second portion 14 are such that the bottom portion of the second post is biased toward the rear of the bicycle 50. The angle of the second post 34 with respect to the first post 32 is therefore biased before a load 100 is applied resulting in the second post axis 35 and first post axis 33 being out of a coaxial relationship. As the load 100 is applied to the seat 52 and the dropper seat post 30, the rear sideload force 104 operates to move the upper portion of the second post 34 toward the rear of the bicycle 50 and compresses the first portion 12 of the non-uniform thickness bushing 10 and move the second post axis 35 to as close to coaxial as possible with the first post axis 33. This operation of the dropper seat post 30 with the non-uniform bushing 10 improves the axial alignment of the second post 34 and the first post 32 when loaded by the rider. With better axial alignment, running friction can be reduced, binding is reduced and there is a decreased chance of wearing internal parts.

While it is depicted with the non-uniform thickness bushing 12 is located at the position of the lower bushing, it will be understood that it may be used at the location of the upper bushing, wherein the first portion 12 faces a rear of the bicycle 50 to bias the second post 34 in the correct direction given the direction of the sideload force 104. In additional embodiments a non-uniform thickness bushing may be used both as the upper and the lower bushing with the first portion of the upper bushing facing the rear of the bicycle 50 and the first portion of the lower bushing facing the front of the bicycle 50.

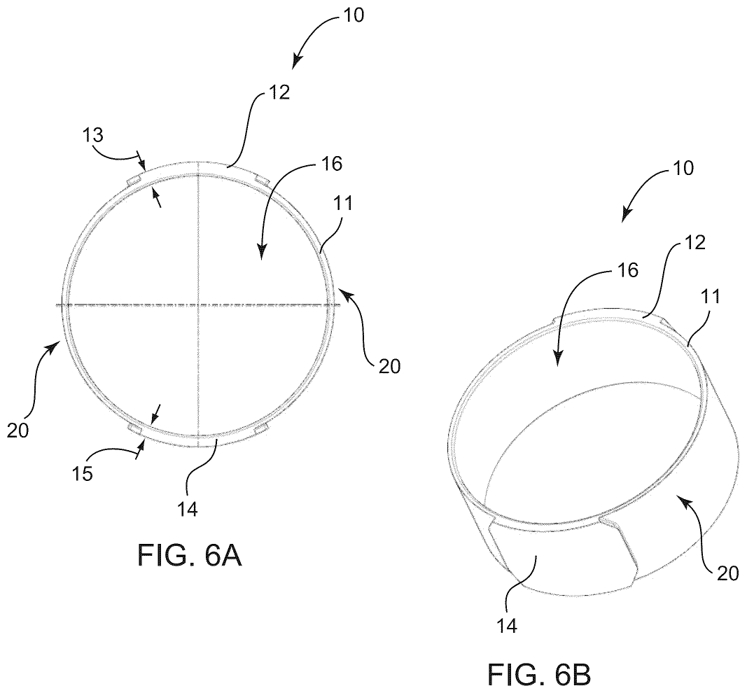

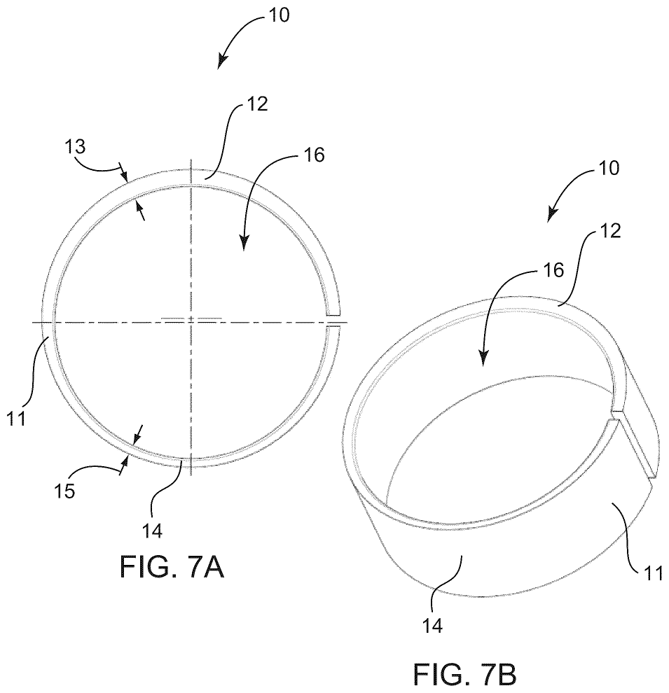

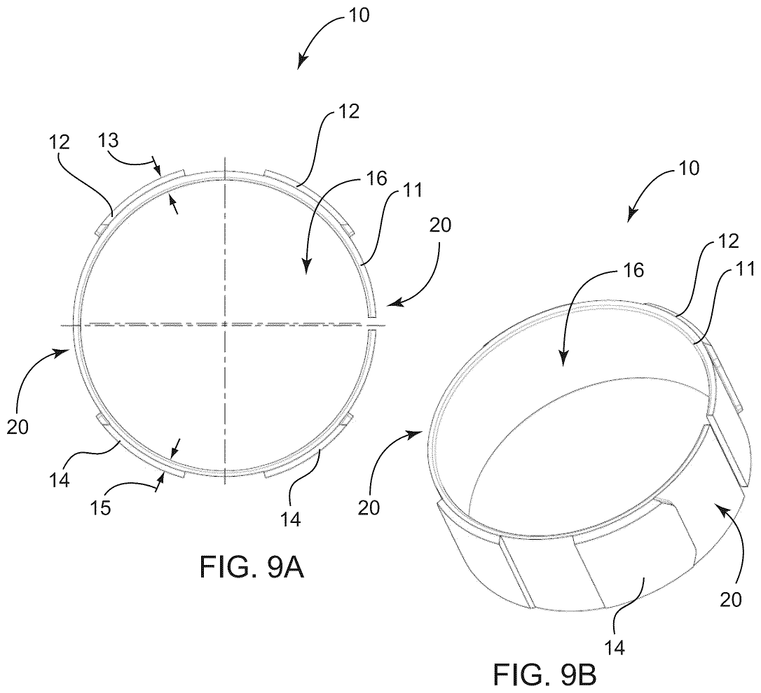

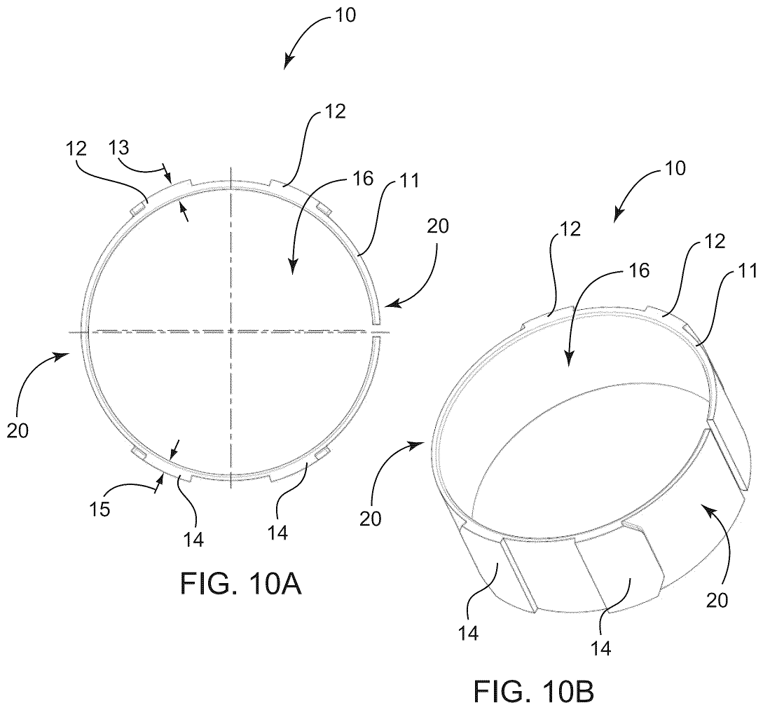

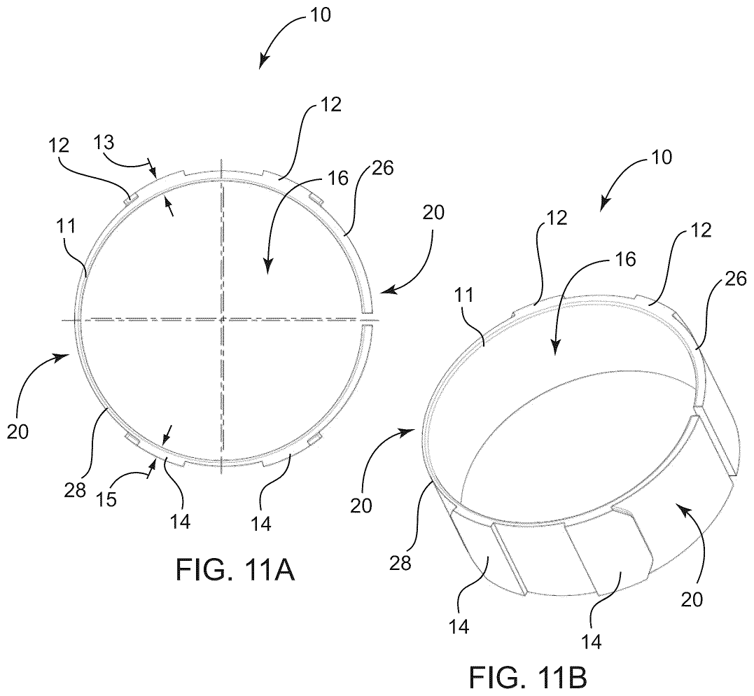

Additional embodiments of the non-uniform bushings 10 are depicted in FIGS. 6A-11B. FIGS. 6A-6B depict a different dimensioned first and second portions 12 and 14 with no opening 18; FIGS. 7A-7B a continuous reduction in thickness from the first portion 12 to the second portion 14; FIGS. 9A-9B depict the first portion 12 and the second portion 14 as two members with a space between the two parts; and FIGS. 10A-10B is similar to FIGS. 9A-9B and depict the first portion 12 and the second portion 14 as two members with a space between the two parts with the parts of the first portion 12 and the second portion 14 are smaller than the same components depicted in FIGS. 9A-9B. FIGS. 11A-11B depict a slightly different embodiment that can account for a telescopic assembly 30 that may include a side load in two different directions. In this embodiment, the non-uniform thickness bushing 10 includes a first portion 12, a second portion 13, a fourth portion 26 and a fifth portion 28, wherein the thickness of the first portion 12 is greater than the second portion 13 and the thickness of the fourth portion 26 is greater than the thickness of the fifth portion 28. This loads the second post 34 out of coaxial alignment with the first post 32 in two directions as shown in FIG. 11A. Then when two sideload forces are applied, the axis of the second post 34 and the axis of the first post 32 may be moved as close to coaxial as possible.

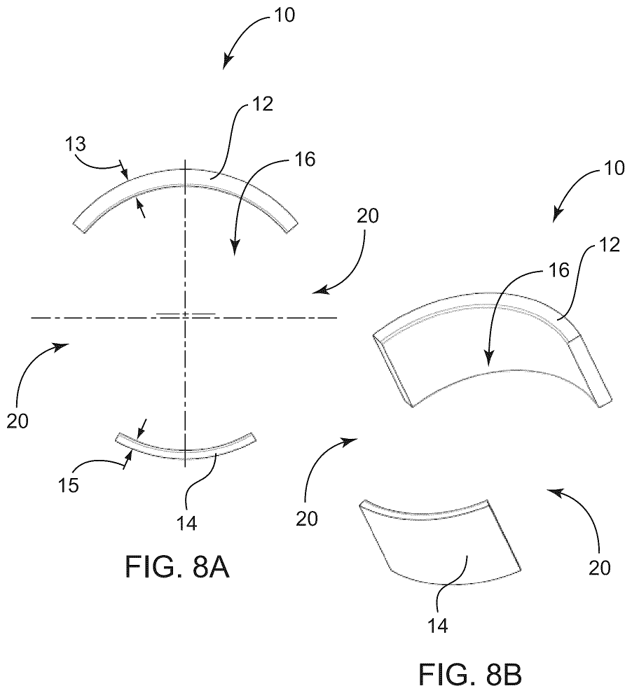

The non-uniform bushings 10 may be a single component according to some embodiments or may be a plurality of separate components. For example, as depicted in FIGS. 8A-8B, an embodiment of the non-uniform bushing 10 comprises a first portion 12 spaced and separated from the second portion 14 forming the aperture 16. The non-uniform bushing 10 may include a gap 20 located on opposing sides of and between the first portion 12 and the second portion 14, thereby separating the first portion 12 and the second portion 14.

Embodiments may include a telescopic assembly having a first telescopic member and a second telescopic member slidably coupled within the first telescopic member. The first portion 12 and the second portion 14 may be coupled to an end of the second telescopic member and located between an outer surface of the second telescopic member and an inner surface of the first telescopic member. In embodiments, the first portion 12 and second portion 14 may be axially offset from one another along an axis of the second telescopic member. In operation, the first portion 12 of the non-uniform thickness bushing 10 places an axis of the second telescopic member in a position out of coaxial alignment with an axis of the first telescopic member when there is no load on the second telescopic member. In response to a side load applied to the second telescopic member in a direction opposite the direction the first portion 12 of the non-uniform thickness bushing 10 faces, the second telescopic member is moved with respect to the first telescopic member such that the axis of the second telescopic member and the axis of the first telescopic member are in a near coaxial position.

While depicted in the drawing figures that the telescopic assembly is a dropper seat post 30, it will be understood that other telescopic assemblies 30 may utilize the same non-uniform bushing 10. Such telescopic assemblies 30 may be particularly used for a vehicle. One specific telescopic assembly may be a telescopic suspension 30 that includes the non-uniform thickness bushing 10 and operates in the same fashion as described above to place a second telescopic member or second post 34 in a position out of coaxial alignment with a first telescopic member or first post 32 when there is no load because of the bushing 10 and then once the load 100 is applied resulting in an axial load 102 and a side load 104, the second telescopic member 32 is moved with respect to the first telescopic member 34 such that the axis of the second telescopic member 32 and the axis of the first telescopic member 32 are in a near coaxial position.

Another embodiment may include a method of operating a telescopic assembly with a non-uniform thickness bushing. The method may include biasing a bottom portion of a second post in a direction opposite to a direction of a sideload force to be applied placing an axis of the second post out of a coaxial position from an axis of a bottom post; applying both an axial force and a sideload force to an second post; and moving the second post into a near coaxial position with the first post allowing the axial force to move the second post with respect to the first post. The step of biasing the bottom portion of the second post is performed in response to coupling a non-uniform thickness bushing to the bottom portion of the second post. Additional method steps are clearly discussed in the above description of the telescopic assembly 30 with the non-uniform thickness bushing 10.

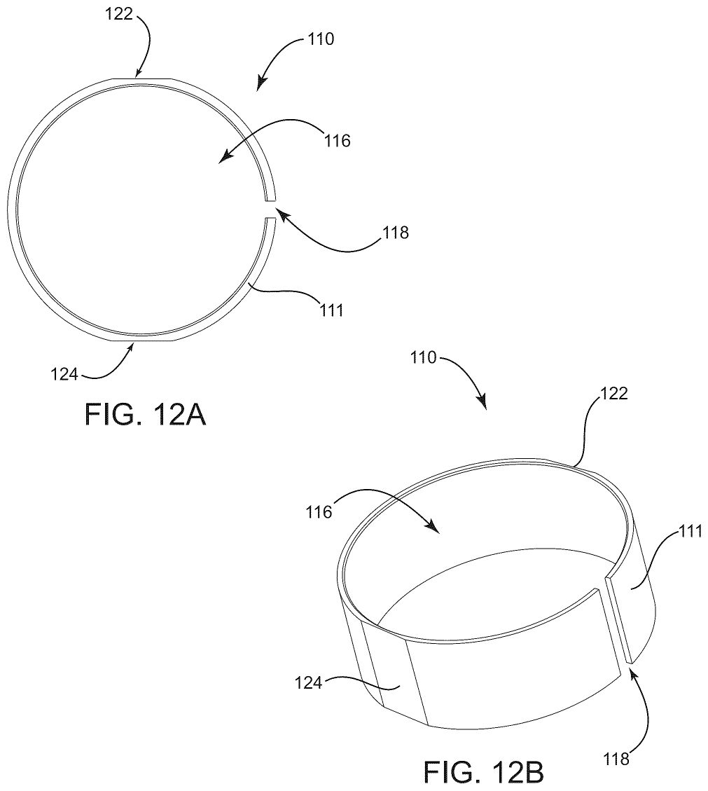

Additionally, embodiments of various telescopic assemblies on a vehicle, such as a bicycle include the use of uniform bushings, such as uniform bushing 110 depicted in FIGS. 12A and 12B. The uniform bushing 110 may include a bushing body 111 with an aperture 116 extending therethrough. The bushing body 11 may include a first flat surface 122 and a second flat surface 124, wherein the first flat surface 122 is located on an opposite side of the bushing body 111 from the second flat surface 124. The first and second flat surfaces 122 and 124 may be used to make molding of the bushing 110 easier, but also provide an additional benefit. The first and second flat surfaces 122 and 124 are located at the front and back respectively to help prevent binding as the bushing 110 passes through the seat post clamp on the frame. The uniform bushing 110 may include an opening 118 extending through the bushing body 111 that allows for greater ease of installing the uniform bushing 110 onto a seat post or other telescopic member.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A non-uniform thickness bushing for a telescopic assembly used in a vehicle, the non-uniform thickness bushing comprising:
a first portion on one side of the non-uniform thickness bushing, the first portion having a first thickness; and
a second portion on a side of the non-uniform thickness bushing opposite the side of the first portion, the second portion having a second thickness, wherein the first thickness is greater than the second thickness.

2. The non-uniform thickness bushing of claim 1, further comprising a gap located on opposing sides of the non-uniform thickness bushing and between the first portion and the second portion.

3. The non-uniform thickness bushing of claim 1, further comprising a bushing body forming a ring with an aperture extending therethrough, wherein the first portion and the second portion extend from the bushing body.

4. The non-uniform thickness bushing of claim 1, further comprising a telescopic assembly having a first telescopic member and a second telescopic member slidably coupled within the first telescopic member, wherein the non-uniform thickness bushing is coupled to an end of the second telescopic member and located between an outer surface of the second telescopic member and an inner surface of the first telescopic member.

5. The non-uniform thickness bushing of claim 4, wherein the non-uniform thickness bushing places an axis of the second telescopic member in a position out of coaxial alignment with an axis of the first telescopic member when there is no load on the second telescopic member.

6. The non-uniform thickness bushing of claim 5, in response to a side load applied to the second telescopic member in a direction opposite the direction the first portion of the non-uniform thickness bushing faces, the second telescopic member is moved with respect to the first telescopic member such that the axis of the second telescopic member and the axis of the first telescopic member are in a near coaxial position.

7. The non-uniform thickness bushing of claim 1, further comprising a gap located on opposing sides of and between the first portion and the second portion, thereby separating the first portion and the second portion.

8. The non-uniform thickness bushing of claim 7, further comprising a telescopic assembly having a first telescopic member and a second telescopic member slidably coupled within the first telescopic member, wherein first portion and the second portion are coupled to an end of the second telescopic member and located between an outer surface of the second telescopic member and an inner surface of the first telescopic member.

9. The non-uniform thickness bushing of claim 8, wherein the first portion and second portion are axially offset from one another along an axis of the second telescopic member.

10. The non-uniform thickness bushing of claim 8, wherein the first portion of the non-uniform thickness bushing places an axis of the second telescopic member in a position out of coaxial alignment with an axis of the first telescopic member when there is no load on the second telescopic member.

11. The non-uniform thickness bushing of claim 10, in response to a side load applied to the second telescopic member in a direction opposite the direction the first portion of the non-uniform thickness bushing faces, the second telescopic member is moved with respect to the first telescopic member such that the axis of the second telescopic member and the axis of the first telescopic member are in a near coaxial position.

12. A telescopic suspension comprising:
a telescopic assembly comprising a first telescopic member having an axis and a second telescopic member having an axis, the second telescopic member slidably coupled within the first telescopic member;
a non-uniform thickness bushing coupled to an end of the second telescopic member and located between an outer surface of the second telescopic member and an inner surface of the first telescopic member, wherein the non-uniform thickness bushing comprises:
a first portion on one side of the non-uniform thickness bushing, the first portion having a first thickness; and
a second portion on a side of the non-uniform thickness bushing opposite the side of the first portion, the second portion having a second thickness, wherein the first thickness is greater than the second thickness; and
wherein the non-uniform thickness bushing places the axis of the second telescopic member in a position out of coaxial alignment with the axis of the first telescopic member when there is no load on the second telescopic member.

13. The non-uniform thickness bushing of claim 12, further comprising a gap located on opposing sides of the non-uniform thickness bushing and between the first portion and the second portion.

14. The non-uniform thickness bushing of claim 12, further comprising a bushing body forming a ring with an aperture extending therethrough, wherein the first portion and the second portion extend from the bushing body.

15. The non-uniform thickness bushing of claim 12, in response to a side load applied to the second telescopic member in a direction opposite the direction the first portion of the non-uniform thickness bushing faces, the second telescopic member is moved with respect to the first telescopic member such that the axis of the second telescopic member and the axis of the first telescopic member are in a near coaxial position.

16. A dropper seat post comprising:
a first post having an axis;
a second post having an axis, the second post slidably coupled within the first post;
a non-uniform thickness bushing coupled to an end of the second post and located between an outer surface of the second post and an inner surface of the first post, wherein the non-uniform thickness bushing comprises:
a first portion on one side of the non-uniform thickness bushing, the first portion having a first thickness that when coupled to the second post faces a front of a bicycle to which the dropper seat post is coupled; and
a second portion on a side of the non-uniform thickness bushing opposite the side of the first portion, the second portion having a second thickness, wherein the first thickness is greater than the second thickness; and
wherein the non-uniform thickness bushing places the axis of the second post in a position out of coaxial alignment with the axis of the first post when there is no load on the second post.

17. The non-uniform thickness bushing of claim 16, further comprising a gap located on opposing sides of the non-uniform thickness bushing and between the first portion and the second portion.

18. The non-uniform thickness bushing of claim 16, further comprising a directional indicator indicating the side of the bushing body the first portion extends from.

19. The non-uniform thickness bushing of claim 16, further comprising a bushing body forming a ring with an aperture extending therethrough, wherein the first portion and the second portion extend from the bushing body.

20. The non-uniform thickness bushing of claim 16, in response to a side load applied to the second post toward a rear of the bicycle, the second post is moved with respect to the first post such that the axis of the second post and the axis of the first post are in a near coaxial position.
